(19) United States
(12) Patent Application Publication
(10) Pub. No.: US 2025/0150365 A1
(43) Pub. Date: May 8, 2025

(54) RADIO COMMUNICATION METHOD AND DEVICE, ELECTRONIC APPARATUS AND STORAGE MEDIUM

(71) Applicant: Samsung Electronics Co., Ltd., Suwon-si, Gyeonggi-do (KR)

(72) Inventors: Lisi LI, Beijing (CN); Hong WANG, Beijing (CN); Lixiang XU, Beijing (CN); Weiwei WANG, Beijing (CN)

(21) Appl. No.: 18/727,894

(22) PCT Filed: Dec. 26, 2022
(86) PCT No.: PCT/KR2022/021288

§ 371 Date: Jul. 10, 2024

(30) Foreign Application Priority Data
Jan. 14, 2022 (CN) 202210043365.7

(51) Int. Cl. H04L 41/5067; H04W 24/10; H04W 68/02; H04W 76/20

(52) U.S. Cl. CPC H04L 41/5067; H04W 24/10; H04W 68/02; H04W 76/20

(57) ABSTRACT

The disclosure relates to a 5G or 6G communication system for supporting a higher data transmission rate. The present disclosure relates to a radio communication method and device, an electronic apparatus and a storage medium. A radio communication method executed by a first node includes: acquiring information on a first measurement; transmitting first measurement configuration information to at least one UE based on the acquired information on the first measurement, wherein the first measurement configuration information is used for executing or stopping the first measurement by the UE in an inactive state or an idle state.

### TECHNICAL FIELD

The present disclosure relates to a communication field, and in particular, relates to a radio communication method, a first node, user equipment, a third node, an electronic apparatus and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra- high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In particular, in the fifth generation (5G) and B5G or 6G mobile communication systems, more and more new services, e.g. new 5G services such as AR, MR, cloud games etc., and MBS services and so on, need to be supported,. However, the existing radio communication methods can only support measurements and reporting related to services when the user equipment is in a connected state. However, this is obviously inefficient and is not conducive to network optimization after the operator understands the service situation.

### DISCLOSURE OF INVENTION

### Technical Problem

The present invention has been made to address at least the above problems and/or disadvantages and to provide at least the advantages described below. Accordingly, an aspect of the present invention provides a method and apparatus for performing measurement and measurement report for the UE in the inactive state or the idle state.

### Solution to Problem

The present disclosure provides an image processing method and device, an electronic apparatus and a storage medium so as to at least solve the above problems in the related art.

According to a first aspect of embodiments of the present disclosure, a radio communication method executed by a first node is provided, the radio communication method including: acquiring information on a first measurement; transmitting first measurement configuration information to at least one UE based on the acquired information on the first measurement, wherein the first measurement configuration information is used for executing or stopping the first measurement by the UE in an inactive state or an idle state.

According to a second aspect of the embodiments of the present disclosure, a radio communication method executed by user equipment (UE) is provided, the radio communication method including: receiving first measurement configuration information from a first node; executing or stopping the first measurement in an inactive state or an idle state according to the received first measurement configuration information; and reporting a first measurement report obtained by executing the first measurement in the inactive state or the idle state to a network.

According to a third aspect of the embodiments of the present disclosure, a radio communication method executed by a third node is provided, the radio communication method including: receiving information related to a first measurement report; and receiving and/or forwarding the first measurement report according to the information related to the first measurement report, wherein the first measurement report is obtained by a UE executing the first measurement in an inactive state or an idle state.

According to a fourth aspect of the embodiments of the present disclosure, a first node is provided, the first node including: a communication unit; at least one processor connected with the communication unit and configured to: control the communication unit to acquire information on a first measurement; control the communication unit to transmit first measurement configuration information to at least one UE based on the acquired information on the first measurement, wherein the first measurement configuration information is used for executing or stopping the first measurement by UE in an inactive state or an idle state.

According to a fifth aspect of the embodiments of the present disclosure, a user equipment is provided, the user equipment including: a communication unit; at least one processor connected with the communication unit and configured to: control the communication unit to receive first measurement configuration information from a first node; executing or stopping the first measurement in an inactive state or an idle state according to the received first measurement configuration information; and control the communication unit to report a first measurement report obtained by executing the first measurement in the inactive state or the idle state to a network.

According to a sixth aspect of the embodiments of the present disclosure, a third node is provided, the third node including: a communication unit; at least one processor connected with the communication unit and configured to: control the communication unit to receive information related to a first measurement report; and control the communication unit to receive and/or forward the first measurement report according to the information related to the first measurement report, wherein the first measurement report is obtained by a UE executing the first measurement in an inactive state or an idle state.

According to a seventh aspect of the embodiments of the present disclosure, an electronic apparatus is provided, the electronic apparatus including: at least one processor; and at least one memory storing computer executable instructions, wherein the computer executable instructions, when executed by the at least one processor, cause the at least one processor to execute the above-described radio communication method.

According to an eighth aspect of the embodiments of the present disclosure, a computer readable storage medium storing instructions is provided, which is characterized in: the instructions, when executed by at least one processor, cause the at least one processor to execute the above-described radio communication method.

The technical solution provided by the embodiments of the present disclosure at least brings the following advantageous effects: it is capable of supporting a network to perform the first measurement and measurement report for the UE in the inactive state or the idle state, so as to facilitate the operators to collect the service situations of the users in the inactive state or the idle state, thereby further optimizing and adjusting the network, improving the user service experience, finally improving user loyalty and increasing operator revenue.

It should be understood that the above general description and the following detail description are merely exemplary and illustrative without limiting the present disclosure.

### Advantageous Effects of Invention

Advantages, and salient features of the invention will become apparent to those skilled in the art from the following detailed description, which, taken in conjunction with the annexed drawings, discloses exemplary embodiments of the invention. According to the present invention, it is capable of optimize and adjust a network, improve the user service experience, improve user loyalty and increase operator revenue.

### BRIEF DESCRIPTION OF DRAWINGS

The drawings here are incorporated into the description and constitute a part of the description, illustrate exemplary embodiments conforming to the present disclosure, explain a principle of the present disclosure together with the description, and do not constitute inappropriate definition for the present disclosure.

FIG. 1 is an exemplary system architecture of a System Architecture Evolution (SAE).

FIG. 2 is an exemplary system architecture 200 according to various embodiments of the present disclosure.

FIG. 3 is a schematic diagram illustrating QoE measurement collection configuration and reporting process.

FIG. 4 is a schematic diagram illustrating a radio communication method according to an exemplary embodiment of the present disclosure.

FIG. 5A is a schematic diagram illustrating a first example of the radio communication method according to the exemplary embodiment of the present disclosure.

FIG. 5B is a schematic diagram illustrating a second example of the radio communication method according to the exemplary embodiment of the present disclosure.

FIG. 5C is a schematic diagram illustrating a third example of the radio communication method according to the exemplary embodiment of the present disclosure.

FIG. 6A is a schematic diagram illustrating a fourth example of the radio communication method according to the exemplary embodiment of the present disclosure.

FIG. 6B is a schematic diagram illustrating a fifth example of the radio communication method according to the exemplary embodiment of the present disclosure.

FIG. 7 is a flowchart of a radio communication method executed by a third node according to an exemplary embodiment of the present disclosure.

FIG. 8 is a schematic diagram illustrating a sixth example of the radio communication method according to the exemplary embodiment of the present disclosure.

FIG. 9 is a flowchart of a radio communication method executed by a first node according to an exemplary embodiment of the present disclosure.

FIG. 10 is a flowchart of a radio communication method executed by a user equipment (UE) according to an exemplary embodiment of the present disclosure.

FIG. 11 is a block diagram of a first node according to an exemplary embodiment of the present disclosure.

FIG. 12 is a block diagram of a user equipment according to an exemplary embodiment of the present disclosure.

FIG. 13 is a block diagram of a third node according to an exemplary embodiment of the present disclosure.

FIG. 14 is a block diagram of an electronic apparatus according to an exemplary embodiment of the present disclosure.

### MODE FOR THE INVENTION

In order to enable those ordinarily skilled in the art to understand the technical solutions of the present disclosure better, hereinafter, the technical solutions in the embodiments of the present disclosure will be described clearly and completely in conjunction with the drawings.

It should be explained that terms “first”, “second” and the like in the description and the claims as well as the drawings of the present disclosure are used to distinguish similar objects, and are not necessary to be used to describe specific order or sequence.

It should be understood that the data used in this way can be interchanged under appropriate circumstances so that the embodiments of the present disclosure described herein can be implemented in an order other than those illustrated or described herein. Implementation manners described in the following embodiments do not represent all of the implementation manners that are consistent with the present disclosure. On the contrary, they are merely examples of devices and methods consistent with some aspects of the present disclosure as described in detail in the appended claims.

It should be explained here that “at least one of several items” appearing in the present disclosure all means to include these three parallel situations of “any one of the several items”, “a combination of any multiple of the several items”, and “the totality of the several items”. For example, “including at least one of A and B” for example includes the following three parallel situations: (1) including A; (2) including B; and (3) including A and B. For another example, “executing at least one of step 1 and step 2” for example represents the following three parallel situations: (1) executing step 1; (2) executing step 2; and (3) executing step 1 and step 2.

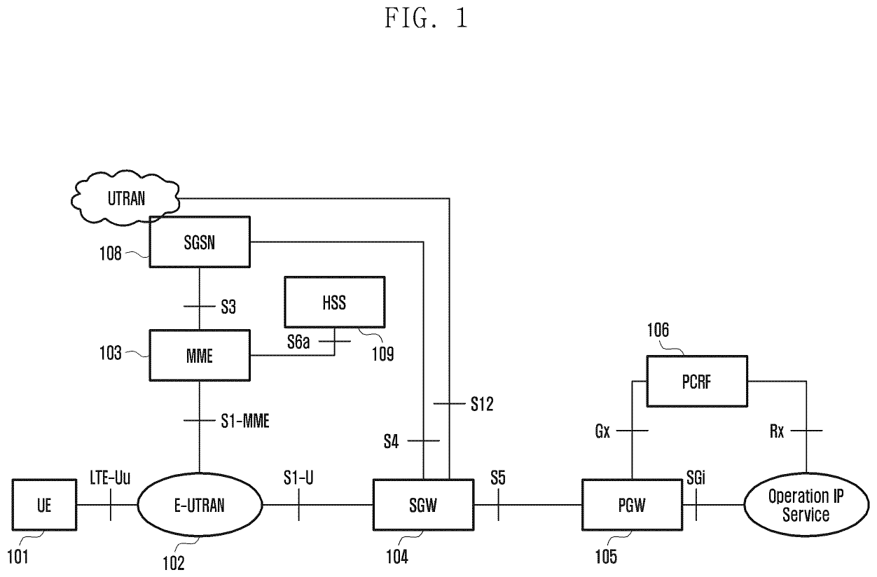

FIGS. 1 to 14 discussed below and various embodiments for describing the principle of the present disclosure in the patent documents are merely illustrative, and should not be construed in any way to limit the scope of the present disclosure. Those skilled in the art will understand that the principle of the present disclosure may be implemented in any suitably arranged system or apparatus.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

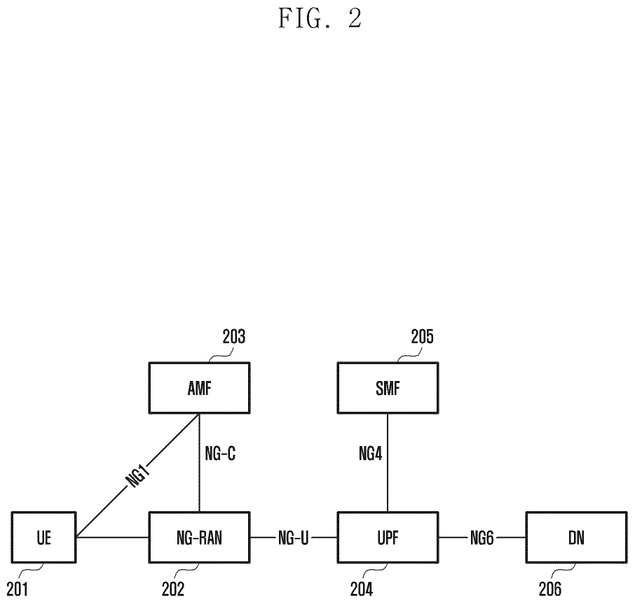

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

With the development needs of wireless technology, in the 5G architecture, functional modules originally located on the same base station are separated. Some functional modules are getting closer to users, while other modules are pooled and virtualized for centralized deployment. That is to say, a base station can be divided into two parts, one of which is a Central Unit (abbreviated as CU), and the other part is a Distribution Unit (abbreviated as DU). DU is much closer to users, while CU is far away from antennas to be able to support multi-antenna connection, and improve network performance. One CU may be connected to multiple DUs, and functions on CU may be virtualized. CU and DU are connected through an interface F1, and the interface F1 is also called fronthaul interface or fronthaul connection. Functions of Radio Resource Control (RRC), Packet Data Convergence Protocol (PDCP) are implemented on CU, and functions of Radio Link Control (RLC), Media Access Control (MAC) and physical layers are implemented on DU.

In the third generation (3G) and fourth generation (4G) mobile communication systems, service quality of experience (abbreviated as QoE) measurement collection for streaming media services and multimedia telephony services has been standardized by 3rd Generation Partnership Project (abbreviated as 3GPP). QoE Measurement Collection (abbreviated as QMC) can collect UE application layer measurement information, which may be measurement collection for a specific service or a certain type of service of a specific UE within a certain area. The collected information may be transmitted to a data center (e.g., Measurement Collector Entity, (abbreviated as MCE)), and is then used to analyze and/or calculate Key Performance Indicators (abbreviated as KPIs) so as to optimize the network and improve the use service experience, and ultimately enhance user loyalty and increase revenue.

However, in the fifth generation (5G) and B5G or 6G mobile communication systems, more and more new services need to be supported, e.g. new 5G services such as AR, MR, cloud games, and MBS services in RRC_CONNECTED, RRC_INACTIVE and RRC_ IDLE states are also supported. Thus, how to collect QoE to optimize the network when the UE is in the RRC_INACTIVE or RRC_IDLE state is an important direction worthy of research.

The QoE measurement in the present disclosure can also be called QoE measurement collection (i.e., QMC), which refers to the QoE measurement configured by the 3GPP network and executed by the UE, and finally these measurement results will be reported to the 3GPP network or the operator server. According to the initiation method, it can be divided into management-based QMC measurement and signaling-based QMC. According to an implementation method, QMC may be initiated by a network element management node, and this type of QMC is called management-based QMC. In the management-based QMC, an access network entity receives QMC configuration information from a network element management node. According to another implementation method, QMC may be initiated by a core network node, and this type of QMC is called signaling-based QMC. In the signaling-based QMC, an access network entity receives QMC configuration information from a core network entity. In some examples, a core network entity may be Access and Mobility Management Function (AMF). However, it should be understood that this is only an example. The core network entity transmitting a QMC configuration message may also be another entity.

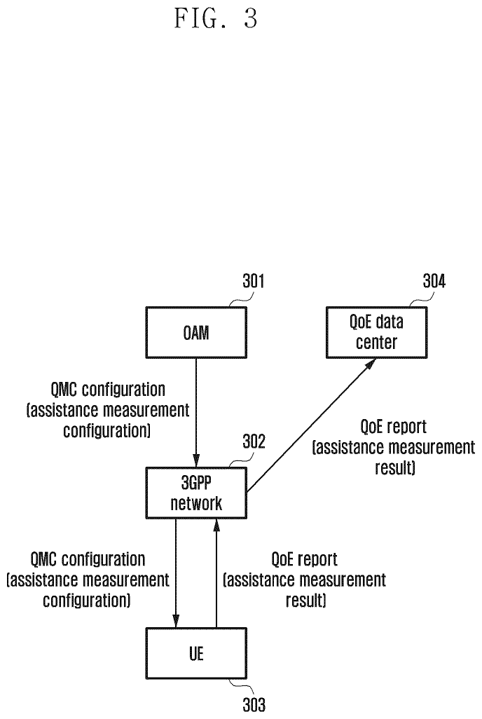

FIG. 3 is a schematic diagram illustrating QoE measurement collection configuration and reporting process. As illustrated in FIG. 3, Operations, Administration and Maintenance (abbreviated as OAM) node 301 transmits a QMC configuration message to 3GPP network 302. The 3GPP network 302 includes a core network node or an access network node, the core network node may include nodes such as UDM, AMF, SMF or UPF etc., and the access network node may be eNB of 4G system, or gNB or eNB of 5G system, or may also be a base station in another system. The QMC message includes QMC configuration information and/or assistance measurement configuration information. The assistance measurement configuration information refers to that while the UE application layer measures QoE, the node in the 3GPP network and/or the UE access layer also execute(s) the associated assistance measurement at the same time to assist the optimization analysis of the QoE problem. The associated assistance measurement refers to assistance measurement that needs to be temporally consistent or aligned with application layer measurement.

The 3GPP network 302 may initiate activation of a QMC procedure, which may be divided into management-based QMC and signaling-based QMC according to different activated nodes. If the activation of QMC is directly triggered by OAM through a base station, this process belongs to the management-based QMC procedure, and if the activation of QMC is triggered by a core network node, this process belongs to the signaling-based QMC procedure. Regardless of the triggering method, the 3GPP network 302 will send the QMC configuration to the UE that meets the conditions. If the QMC configuration includes configuration of the assistance measurement, the assistance measurement configuration may be specific to the network node or specific to the UE. A node configured with assistance measurement also needs to store assistance measurement configuration information and activate measurement when appropriate.

At the beginning of each service session, the UE 303 determines whether to enable QoE measurement according to configuration conditions, and at the same time, the node configured with the assistance measurement also needs to perform the associated assistance measurement. Finally, the UE transmits measurement results (including a QoE report and/or assistance measurement results) to the configured QoE data processing center 304 through the access network node in the 3GPP network 302, and the QoE data processing center 304 may be a Trace Collection Entity (TCE)/Measurement Collection Entity (MCE). On the other hand, the node configured with assistance measurement in the 3GPP network 302 also needs to transmit the measurement results to 304, so that the operator can make further QoE problem analysis and network optimization.

The above assistance measurement may help the operators to obtain assistance measurement information corresponding to QoE measurement while collecting service quality of experience, and the operators may use the assistance measurement results to analyze the reasons why the QoE becomes worse more rapidly and accurately so as to optimize the network more accurately and improve the quality of user service experience, thereby enhancing user loyalty and increasing operator revenue.

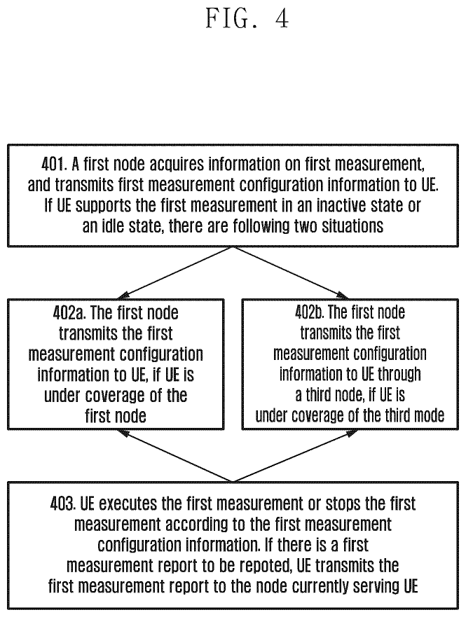

A radio communication method according to various exemplary embodiments of the present disclosure will be described below with reference to FIGS. 4 to 10.

FIG. 4 is a schematic diagram illustrating a radio communication method according to an exemplary embodiment of the present disclosure. Detailed description of steps unrelated to the present disclosure is omitted here. As illustrated in FIG. 4, the method includes following steps:

Step 401, a first node acquires information on a first measurement, for example, the first node receives the information on the first measurement from a second node, or the first node itself generates the information on the first measurement. The first measurement may include a QoE measurement and/or an assistance measurement associated with the QoE measurement. The first node is a service node of a UE or a last service node, that is, the first node has or stores UE context. The first node may be a base station, the second node may be a core network node or OAM or a base station, and the core network node may be AMF if the second node is a core network node. According to one embodiment, the first node is a base station, the second node is a core network node, the information on the first measurement is included in an initial context setup request message, a UE context modification request message, a UE context release command, a trace start message, a handover request message, a handover required message, a paging message or other NGAP messages transmitted by the core network node to the base station; according to another embodiment, the first node is a base station, the second node is a base station, the information on the first measurement is included in a handover request acknowledge message, a retrieve UE context response message, a retrieve UE context failure message, or other XnAP messages transmitted by a source base station as the second node to a target base station as the first node, or the information on the first measurement is included in a secondary node addition request message transmitted by a Master Node (abbreviated as MN) as the second node to a Secondary Node (abbreviated as SN) as the first node, or is included in a secondary node addition request acknowledge message, or other XnAP messages for MR-DC transmitted by the SN as the second node to the MN as the first node; according to another embodiment, the first node is a base station, a second node is OAM, the information on the first measurement is included in an instruction or message to activate QoE configuration, deactivate QoE configuration, or modify QoE configuration. It should be understood that the above are only examples, and the first node, the second node, and the message including the information on the first measurement are not limited thereto. According to one embodiment, the first measurement may be a measurement related to a UE application layer (e.g., QoE measurement at the UE application layer), and there may be one or more first measurements, and it should be understood that the above is only an example, the first measurement is not limited thereto. The information on the first measurement may be information to activate the first measurement, information to deactivate the first measurement, or information to modify the first measurement. The information on the first measurement may include one or more first measurements. That is, multiple first measurements (e.g., QoE measurements) may be configured for one UE simultaneously, for example, the multiple first measurements may include QoE measurements for video services, QoE measurements for voice services, or QoE measurements for MBS services, etc. The information to activate the first measurement or the information to modify the first measurement may include, but is not limited to, contents of the first measurement, information related to reporting of the first measurement (e.g., time when the first measurement is reported, a destination address to which the first measurement is reported, reporting period information of a first measurement report), condition information of the first measurement, and/or information related to state(s) of the UE, etc. Here, the reporting period information of the first measurement report is explicit or visible to the first node. The condition information of the first measurement may include, but is not limited to, an area range and/or a network slice range, etc. The area range may include a RNA notification area, and the condition information of the first measurement may be used for the first node to select the UE that meets the condition to start or stop the first measurement, or the condition information of the first measurement may be used by the first node to decide whether the specific UE to start or stop the first measurement, that is, the selected UE or the specific UE needs to perform the first measurement configuration. For example, the selected UE is a UE that requests to execute the first measurement in management-based QMC. The specific UE is a UE that requests to execute the first measurement in signaling-based QMC. The information related to state(s) of the UE may include, but is not limited to, a state range and/or a state indication, both of which may be used to indicate states in which the UE can execute the first measurement.

According to another exemplary embodiment, the information on the first measurement may also be specific to at least one specific UE. In this case, the first node does not have to select at least one UE based on the information on the first measurement.

First measurement configuration information is transmitted to the at least one UE based on the acquired information on the first measurement, after the information on the first measurement is acquired. For example, it may be first to determine the at least one UE to which the information on the first measurement is specific, or select the at least one UE based on the acquired information on the first measurement. Then, the first measurement configuration information is transmitted to the at least one UE if the at least one UE supports the first measurement in the inactive state or the idle state. As an example, the first node acquires the information on the first measurement, and selects a UE to start the first measurement or stop the first measurement or decides a specific UE to start the first measurement or stop the first measurement according to the information on the first measurement. Here, the selected UE or the specific UE is a UE that is capable of supporting execution of the first measurement in the inactive state or the idle state. As an example, a current state of the UE capable of supporting the execution of the first measurement in the inactive state or the idle state may be either an inactive state, an idle state, or a connected state. If the selected UE or the specific UE supports the first measurement in the inactive state (RRC_INACTIVE) or the idle state (RRC_IDLE), the first node directly transmits the first measurement configuration information to the UE or indirectly transmits the first measurement configuration information to the UE through the third node. It needs to explain that the first node may transmit the first measurement configuration information to all the selected UEs, or transmit the first measurement configuration information to some selected UEs, or transmit the first measurement configuration information to the specific UE. In addition, it needs to explain that the information on the first measurement and the first measurement configuration information may be the same, or may be different. According to different nodes where the UE is located, there are the following two situations:

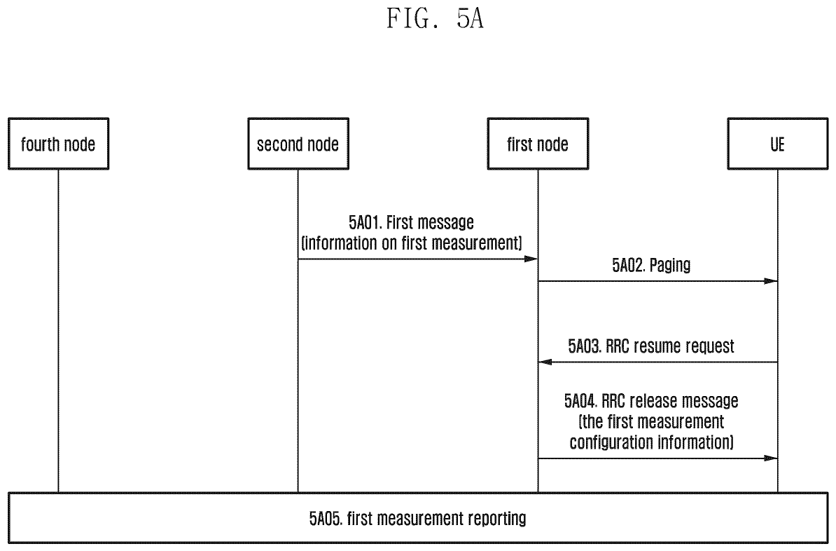

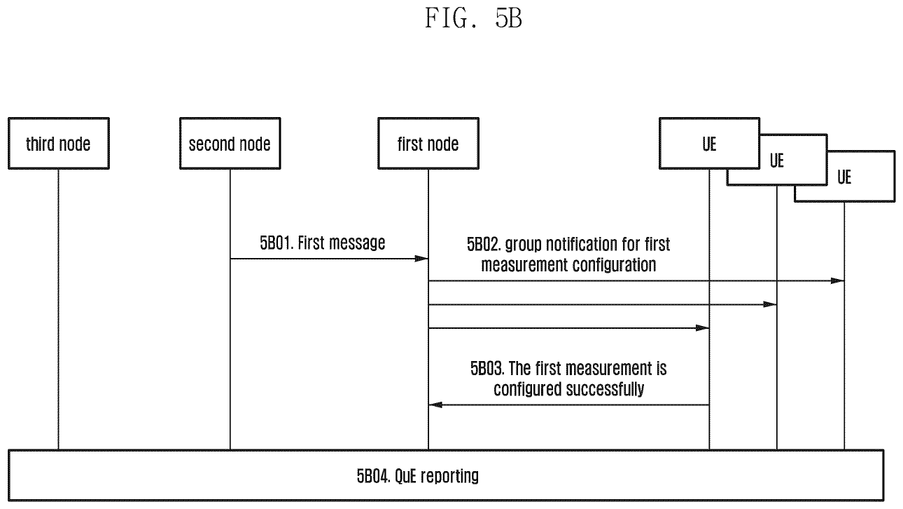

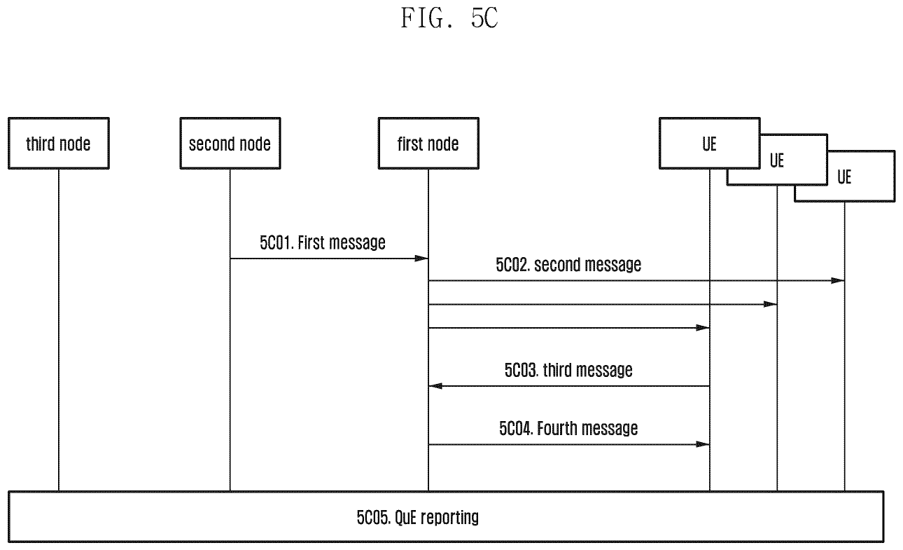

Situation 1: corresponding to step 402a, the first node directly transmits the first measurement configuration information to the UE if the selected UE or the specific UE is under coverage of the first node. According to one embodiment, the first node may transmit the first measurement configuration information to the UE through a message for group notification, for example, the first node may transmit the first measurement configuration information to the UE through a broadcast or multi-cast control message (such as a message transferred by using a multi-cast control channel (MCCH) or multi-cast traffic channel (MTCH) channel) (such as examples illustrated in FIGS. 5B and 5C). According to another embodiment, the first node transmits the indication related to the first measurement to the UE through a group paging or paging message, and after the UE responds to the paging, the first node transmits the first measurement configuration information to the UE through a message associated with the UE (e.g., an RRC message, wherein the RRC message may be an RRC reconfiguration message or an RRC release message or an RRC reject message or an RRC message including a NAS message, etc.) (for example, an example illustrated in FIG. 5A). It should be understood that the above is only an example, and the methods of how the first node transmits the first measurement configuration information to the UE are not limited thereto. In the present disclosure, the message associated with the UE refers to a message related to the UE, for example, the message is transmitted on an air interface through a logical channel of Dedicated Control Channel (DCCH). In the present disclosure, the paging message is a message for notifying one or more UEs, and the paging message may include identification information of UE for indicating the paging (e.g., UE paging identification). As an example, the paging message may include a group paging message, the group paging message is a paging message for notifying one or more UEs in a UE group, and the group paging message may include group identification information of the UE group (e.g., group paging identification).

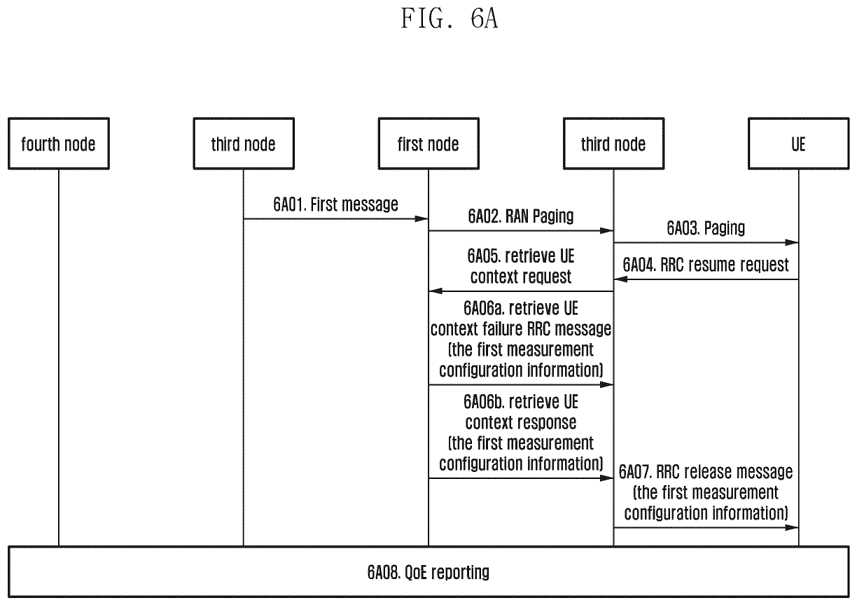

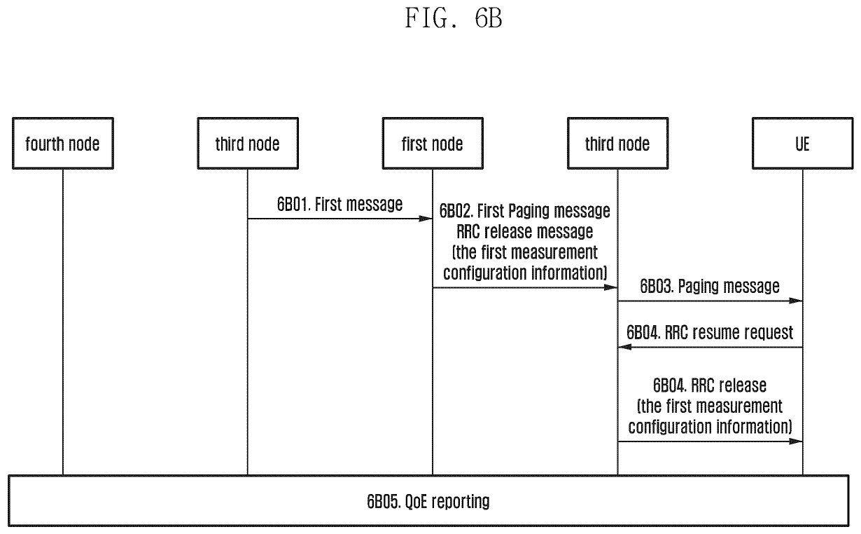

Situation 2: corresponding to step 402b, the first node transmits the first measurement configuration information to the UE through the third node if the selected UE or the specific UE is under coverage of the third node. The third node may be a base station, and the third node is a node without UE context. According to one embodiment, if the first node decides to relocate the UE context to the third node, the first node transmits the first measurement configuration information to the third node through a retrieve UE context procedure, and the third node then transmits the first measurement configuration information to the UE through the message associated with the UE (e.g., an RRC reconfiguration message or an RRC release message, etc.) (e.g., an example illustrated in FIG. 6A). According to another embodiment, if the first node decides to maintain the UE context, i.e., not to relocate the UE context to the third node, the first node may include the first measurement configuration information in a message associated with the UE (e.g., an RRC message related to the UE), and then transmit the message associated with the UE to the third node in a form of a container, and the third node does not read the content in the container, and forwards the message associated with the UE in the container to the UE (e.g., an example illustrated in FIG. 6B). It should be understood that the above are only examples, and the methods of how the first node transmits the first measurement configuration information to the UE through the third node are not limited thereto.

Step 403, the UE receives and stores the first measurement configuration information.

If the first measurement configuration information is the information to activate the first measurement or the information to modify the first measurement, in this case, the information indicates that the UE may also execute the first measurement while entering RRC_INACTIVE or RRC_IDLE if the information contains the information related to state(s) of the UE, and the UE will not release the first measurement configuration information while entering the RRC_INACTIVE or RRC_IDLE state. The UE starts the first measurement according to requirements in the first measurement configuration information, and reports a result of the first measurement to a node currently serving the UE according to the requirements in the first measurement configuration information. The node currently serving the UE may be a first node, a third node or other nodes serving the UE. The result of the first measurement may be a first measurement report, and the first measurement report may include state indication information to indicate the states in which the UE executes the first measurement, so as to collect the first measurement results in different states more specifically. The UE may report the first measurement report in the connected state, the inactive state or the idle state. According to one embodiment, if the UE reports the first measurement report in the connected state, the UE may transmit information related to the first measurement report to the node currently serving the UE when the UE enters the connected state, so that the node currently serving the UE may establish a bearer for transmitting the first measurement report, and reasonably allocate radio resources for transmitting the report according to the information related to the first measurement report at the same time, thereby improving resource utilization. In addition, the node currently serving the UE may also smoothly transmit the first measurement report to the node (e.g., MCE) that collects the first measurement report according to the information related to the first measurement report. The information related to the first measurement report includes, but is not limited to, information to indicate that there is a first measurement report to be transmitted, information of a server for collecting the first measurement report, a reporting period of the first measurement report, and information related to segments of the first measurement report, etc.

If the first measurement configuration information is the information to deactivate the first measurement, the UE stops the first measurement according to the requirements in the first measurement configuration information.

Through the above radio communication method, it is capable of supporting a network to perform the QoE configuration and QoE measurement reporting for the UE in the inactive state or the idle state, so as to facilitate the operators to collect the service (e.g., the broadcast multi-cast service) quality experience situations of the users in the inactive or the idle state, thereby further optimizing and adjusting the network, improving the user service experience, and finally improving user loyalty and increasing operator revenue.

FIG. 5A is a schematic diagram illustrating a first example of the radio communication method according to the exemplary embodiment of the present disclosure. Detailed description of steps unrelated to the present disclosure is omitted here. As illustrated in FIG. 5A, the radio communication method includes following steps:

Step 5A01, a first node acquires a first message from a second node, the first message includes information on a first measurement, or the first node itself generates the information on the first measurement. A type of the first message may be related to types of the first node and the second node. According to one embodiment, the first node is a base station, the second node is a core network node, the core network node may be AMF, the first message may be an initial context setup request message, a UE context modification request message, a UE context release command, a trace start message, a handover request message, a handover required message, or other NGAP messages transmitted by the AMF as the second node to the base station as the first node; according to another embodiment, the first node is a base station, the second node is OAM, and the first message may be an instruction or message to activate QoE configuration, deactivate QoE configuration, or modify QoE configuration transmitted by the OAM as the second node to the base station as the first node; according to another embodiment, the first node and the second node both are base stations, and the first message may be a handover request message, a retrieve UE context response message, a retrieve UE context failure message, or other XnAP messages transmitted by a source base station as the second node to a target base station as the first node, or may be a secondary node addition request message transmitted by a Master Node (abbreviated as MN) as the second node to a Secondary Node (abbreviated as SN) as the first node, or may be a secondary node addition request acknowledge message, or other XnAP messages for MR-DC transmitted by the SN as the second node to the MN as the first node; according to another embodiment, the first node is a CU and the second node is a DU, and the first message may be a QoE measurement request message, or QoE measurement stop message, or a QoE measurement modification message, or other F1AP messages, etc. transmitted by the DU as the second node to the CU as the first node. It should be understood that the above are only examples, and the first node, the second node, and the first message are not limited thereto.

The information on the first measurement may be information to activate the first measurement, information to deactivate the first measurement, or information to modify the first measurement.

If the information on the first measurement is the information to activate the first measurement or the information to modify the first measurement, the information includes at least one of:
an area scope, wherein the first node considers the area scope and selects the UE within the area cope to perform the first measurement, the area scope includes an RAN notification area, and the RAN includes one or more cell IDs;
information related to state(s) of UE to indicate the state(s) in which the UE may execute the first measurement, for example, which may be a state range and/or a state indication, wherein the first node considers the information related to the state(s) of the UE to select the UE within the state range to perform the first measurement, and the state range may include RRC_CONNECTED, RRC_INACTIVE and/or RRC_IDLE;
a reporting period of a first measurement report, wherein the first node considers the information to allocate an appropriate radio resource to the UE to transmit the first measurement, when the UE reports the first measurement report.

The first node receives the information on the first measurement, and selects or decides a UE that meets the condition to start the first measurement, or decides a UE that no longer meets the condition to stop the first measurement according to the information on the first measurement (e.g., the area scope thereof, the information related to the state(s) of the UE, etc.), a cell where the UE is currently located, a current state of the UE and/or the capability information of the UE. According to one embodiment, if the information related to the state(s) of the UE indicates that the UE in the RRC_INACTIVE state or the RRC_IDLE state can be selected or decided, the first node may select or decide the UE in the RRC_INACTIVE state or the RRC_IDLE state to perform the first measurement, otherwise, the first node can only select or decide the UE in the RRC_CONNECTED state to perform the first measurement. It should be understood that the above are only examples, and how the first node selects or decides the UE to perform the first measurement is not limited thereto.

Step 5A02, if the selected UE or the specific UE is in the RRC_INACTIVE state or the RRC_IDLE state, the first node transmits a paging message to the UE, and the paging message may be a group paging message or a dedicated paging message. The paging message may include information related to a paging purpose, and the information related to the paging purpose may be, for example, an indication related to the first measurement.

Step 5A03, the UE transmits a response to the paging message to the first node, if the UE receives the paging message. The response to the paging message may include an RRC resume request message or an RRC setup request message. The UE may carry a cause value related to the paging purpose in the RRC resume request message or the RRC setup request message, if the UE receives the information related to the paging purpose in step 5A02.

Step 5A04, the first node receives the RRC resume request message or the RRC setup request message from the UE, and knows that the message is the response to the paging message in step 5A02 according to the cause value (e.g., MT-Access or a cause value related to the paging purpose) carried in the message. If the first node decides to maintain the UE in the RRC_INACTIVE or RRC_IDLE state, the first node may transmit the first measurement configuration information to the UE through the message associated with the UE, for example, the first node may transmit the RRC release message or the RRC reject message to the UE, and the RRC release message or the RRC reject message includes the first measurement configuration information. In addition to the RRC release message or the RRC reject message, the message associated with the UE may also be, for example, an RRC message including a non-access stratum (NAS) message, and the like.

The UE receives the RRC release message or the RRC reject message. If the message includes the first measurement configuration information, the UE starts or stops the first measurement according to the information therein. If the message indicates that the UE may execute the first measurement in the RRC_INACTIVE or RRC_IDLE state, the first measurement configuration information cannot be released when the UE enters the RRC_INACTIVE or RRC_IDLE state.

Step 5A05, if the UE starts the first measurement according to the first measurement configuration information in step 5A04, the UE transmits the first measurement report to the fourth node according to the first measurement configuration information after starting the first measurement. According to one embodiment, the fourth node is different from the first node, and may be an entity that collects the first measurement, such as an MCE; according to another embodiment, the fourth node is the same as the first node. It should be understood that the above are only examples, and the fourth node is not limited thereto. In addition, the UE may report the first measurement report in the connected state, the inactive state or the idle state.

Through the above radio communication method, it is capable of supporting a network to perform the configuration and reporting of the first measurement (e.g., QoE measurement) for the UE in the inactive state or the idle state, so as to facilitate the operators to collect the service (e.g., the broadcast multi-cast service) quality experience situations of the users in the inactive or the idle state, thereby further optimizing and adjusting the network, improving the user service experience, and finally improving user loyalty and increasing operator revenue. The radio communication method is also capable of controlling how the base station selects or decides the UE to perform the first measurement, and flexibly collect the first measurement performed by the UE in different states according to the operator's requirements, so that the operator optimizes the network more purposefully. The method may also maintain the UE in the inactive state or the idle state, and may also transmit the first measurement configuration information to the UE even if the UE does not need to enter the connected state, which prevents the UE from entering the connected state, saves a process of establishing an RRC connection, reduces delay of the first measurement configuration, saves signaling overhead, and saves power for the UE.

FIG. 5B is a schematic diagram illustrating a second example of the radio communication method according to the exemplary embodiment of the present disclosure. Detailed description of steps unrelated to the present disclosure is omitted here. As illustrated in FIG. 5B, the radio communication method includes following steps:

Step 5B01, the content is consistent with that in step 5A01, which will not be repeated here again.

Step 5B02, the first node transmits a second message to one or more UEs in an coverage area, and the second message is a message for group notification. According to one embodiment, the second message may be transferred through a broadcast or multi-cast control channel, but is not limited thereto. The second message may include first measurement configuration information, and the first measurement configuration information may be information to activate the first measurement, information to de-activate the first measurement, or information to modify the first measurement. The first measurement configuration information may include an area scope, information related to a UE state and/or a reporting period of a first measurement report. The specific content is the same as that described in step 5A01, and will not be repeated here.

Step 5B03, the UE receives the second message (including the first measurement configuration information), and the UE decides to start or stop the first measurement according to the first measurement configuration information. For example, the UE decides to start or stop the first measurement according to the first measurement configuration information in combination with its own situation (e.g., ongoing measurement and/or capability of the UE). The UE for which the first measurement is configured successfully transmits a third message to the first node, and the third message may include at least one:
identification information of the UE, e.g., ID information of the UE for indicating a specific UE; and
information on execution of the first measurement, which may be a list, each item in the list including at least one of:
   ID corresponding to the first measurement for indicating a specific first measurement;
   an indication that the first measurement is activated successfully, for indicating that the specific first measurement is activated or modified successfully at the UE side;
   an indication that the first measurement is deactivated successfully, for indicating that the specific first measurement is deactivated successfully at the UE side.

The first node receives the third message.

If the third message includes the indication that the first measurement is activated successfully, the first node stores the information, and establishes a bearer for transferring the first measurement report for UE;
if the message includes the indication that the first measurement is deactivated successfully, the first node releases the information of the UE related to the execution of the first measurement, and releases the bearer for transferring the first measurement report established for UE.

Step 5B04, if the UE starts the first measurement after step 5B03, the first measurement report is transmitted to the fourth node according to the information related to the first measurement report after the first measurement is started. According to one embodiment, the fourth node is different from the first node, and may be an entity that collects the first measurement, such as an MCE; according to another embodiment, the fourth node is the same as the first node, for example, may be the third node or the second node, or the like. It should be understood that the above are only examples, and the fourth node is not limited thereto. In addition, the UE may report the first measurement report in the connected state, the inactive state or the idle state.

Through the above radio communication method, it is capable of supporting a network to perform the configuration and reporting of the first measurement (e.g., QoE measurement) for one or more UEs in the inactive state or the idle state by means of broadcast or multi-cast, so as to facilitate the operators to collect the service (e.g., the broadcast multi-cast service) quality experience situations of the users in the inactive or the idle state, thereby further optimizing and adjusting the network, improving the user service experience, and finally improving user loyalty and increasing operator revenue. The method performs measurement management of multiple UEs by means of broadcast or multi-cast, that is, only one signaling message is needed to activate or deactivate the measurement configurations of multiple UEs, and it is able to maintain the UE in the current state, (e.g., the inactive state or the idle state), which greatly saves the signaling overhead of the air interface and saves the power of the UE.

FIG. 5C is a schematic diagram illustrating a third example of the radio communication method according to the exemplary embodiment of the present disclosure. Detailed description of steps unrelated to the present disclosure is omitted here. As illustrated in FIG. 5C, the radio communication method includes the following steps:

Step 5C01, the content is consistent with that in step 5A01, which will not be repeated here again.

Step 5C02, the first node transmits a second message to the UE in the coverage area, and the second message is a message for group notification. According to one embodiment, the second message may be transferred through a broadcast or multi-cast control channel, but is not limited thereto. The second message may include at least one of:
an indication related to the first measurement for indicating the UE receiving the second message that the first node has the information on the first measurement to be transmitted;
identification information of the first measurement, for example, a first measurement ID, such as a QoE reference, for indicating that the message is related to the specific first measurement;
a service corresponding to the first measurement such as an MBS service, for indicating that the first measurement is related to the specific service.

Step 5C03, the UE receives the second message.

If the UE is performing the first measurement, and the first measurement ID is consistent with that received in step 5C02, the UE transmits the third message to the first node so as to respond to the second message and acquire the first measurement configuration information;
If the UE does not perform the first measurement having the first measurement ID, the UE checks whether to support the service corresponding to the first measurement, and transmits the third message to the first node so as to respond to the second message and acquire the first measurement configuration information, if the UE supports the service corresponding to the first measurement;
if the UE does not perform the first measurement having the first measurement ID, or the UE does not support the service corresponding to the first measurement, the UE does not make any response about the first measurement.

If the UE decides to transmit the third message to the first node, and aims to acquire the first measurement configuration information, the third message may include at least one:
an indication related to the first measurement, for indicating that a reason for the UE to initiate the message is to acquire the first measurement configuration in- formation, which may be a cause value;
identification information of the first measurement, such as a first measurement ID, for indicating to acquire configuration information of a specific first measurement.

According to one embodiment, if the UE is in the RRC_INACTIVE state, the third message is an RRC resume request message; according to another embodiment, if the UE is in the RRC_IDLE state, the third message is an RRC setup request message. It should be understood that the above are only examples, and the third message is not limited thereto.

Step 5C04, if the first node receives the third message from the UE, the first node transmits a fourth message to the UE according to the information in the third message, the fourth message may include the first measurement configuration information, and the first measurement configuration information may be information to activate the first measurement, information to deactivate the first measurement, or information to modify the first measurement.

According to one embodiment, if the UE is in the RRC_INACTIVE state, the forth message is an RRC resume request message or an RRC release message; according to another embodiment, if the UE is in the RRC_IDLE state, the forth message is an RRC setup message or an RRC release message. It should be understood that the above are only examples, and the fourth message is not limited thereto.

Step 5C05, if the UE starts the first measurement after step 5C04, the first measurement report is transmitted to the fourth node according to the information related to the first measurement report. According to one embodiment, the fourth node is different from the first node, and may be an entity that collects the first measurement, such as an MCE; according to another embodiment, the fourth node is the same as the first node, for example, may be the second node or the third node, or the like. It should be understood that the above are only examples, and the fourth node is not limited thereto. In addition, the UE may report the first measurement report in the connected state, the inactive state or the idle state.

Through the above radio communication method, it is capable of supporting a network to perform the configuration and reporting of the first measurement (e.g., QoE measurement) for one or more UEs in the inactive state or the idle state through group paging or by means of broadcast or multi-cast, so as to facilitate the operators to collect the service (e.g., the broadcast multi-cast services) quality experience situations of the users in the inactive or the idle state, thereby further optimizing and adjusting the network, improving the user service experience, and finally improving user loyalty and increasing operator revenue. The method performs measurement management of multiple UEs through the group paging or by means of broadcast or multi-cast, that is, only one signaling message is needed to activate or deactivate the measurement configurations of multiple UEs, and it is able to maintain the UE in the current state, (e.g., the inactive state or the idle state), which greatly saves the signaling overhead between the air interface and the base station and saves the power of the UE at the same time.

FIG. 6A is a schematic diagram illustrating a fourth example of the radio communication method according to the exemplary embodiment of the present disclosure. Detailed description of steps unrelated to the present invention is omitted here. As illustrated in FIG. 6A, the radio communication method includes following steps:

Step 6A01, the content is consistent with that in step 5A01, which will not be repeated here again.

Step 6A02, if the selected UE or a specific UE is not under coverage of the first node, the first node transmits a first paging message to the third node, and the third node may be a base station. The first paging message may be a dedicated paging message (e.g., paging for a specific UE, an RAN paging message) or a group paging message (e.g., paging for multiple UEs within a group), and the first paging message may include at least one of:
identification information of paging, for example, identification information of the paged UE (which may be IDs of the one or more selected UEs, or an ID of the specific UE), or group identification information of the paged UE group (which may be a group ID of a UE group consisting of one or more UEs);
a paging reason (which may also be called a purpose of paging) for indicating a reason of UE paging, for example, which may be the indication related to the first measurement.

Step 6A03, the third node receives the first paging message from the first node. The third node transmits a paging message to one or more UEs, and the paging message may be a dedicated paging or group paging message.

Step 6A04, in response to the paging message in step 6A03, the UE transmits the third message to the third node, and the third message may be an RRC resume request message or an RRC setup request message, wherein the third message carries an ID and a cause value of the UE (e.g., MT-Access or the indication related to the first measurement).

Step 6A05, since the third node does not have a UE context, according to the ID of the UE, the third node transmits a retrieve UE context request message to the first node, wherein the message carries the ID of the UE and the cause value related to the paging purpose (e.g., MT-Access or the indication related to the first measurement).

Step 6A06, the first node knows that the reason why the UE transmits the third message is related to the first measurement according to the ID of the UE and the cause value. The first node transmits the first measurement configuration information to the UE through the third node. According to one embodiment (in step 6A06a), if the first node decides not to redirect the UE context, the first node transmits the retrieve UE context failure message to the third node, wherein the message includes an RRC message consisting of the first node, the RRC message may include the first measurement configuration information, and the RRC message may be an RRC release message, but is not limited thereto. According to another embodiment (in step 6A06b), if the first node decides to redirect the UE context, the first node transmits the retrieve UE context response message to the third node, wherein the message includes an RRC message consisting of the third node, the RRC message includes the first measurement configuration information, and the RRC message may be an RRC release message, or an RRC setup message, or an RRC reconfiguration message, but is not limited thereto. It should be understood that the above are only examples, and the method of how the first node transmits the first measurement configuration information to the UE through the third node is not limited thereto. The information on the first measurement is consistent with the description mentioned in step 5A01, and will not be repeated here.

Step 6A07, the third node transmits the RRC message to the UE, where the RRC message includes the first measurement configuration information. The RRC message may be built by the first node (e.g., step 6A06a), or may be built by the third node (e.g., step 6A06b), and the RRC message may be the RRC release message, or the RRC setup message, or the RRC reconfiguration message, but is not limited thereto.

Step 6A08, the UE receives the first measurement configuration information, and starts or stops the first measurement according to the first measurement configuration information. If the UE needs to report the first measurement report, the UE transmits the first measurement report to the network according to the information related to the first measurement report.

Through the above radio communication method, it is capable of supporting a network to perform the configuration and reporting of the first measurement (e.g., QoE measurement) for the UE in the inactive state or the idle state and in a moving procedure, and it is also capable of configuring the first measurement successfully and supporting the reporting of the first measurement, so as to facilitate the operators to collect the service (e.g., the broadcast multi-cast services) quality experience situations of the mobile users in the inactive or the idle state, thereby further optimizing and adjusting the network, improving the user service experience, and finally improving user loyalty and increasing operator revenue. The method may also control how the base station selects or decides the UE to perform the first measurement, and flexibly collect the first measurement performed by the UE in different states according to the operator's requirements, so that the operator optimizes the network more purposefully. The method may also maintain the UE in the inactive state or the idle state, and transmit the configuration of the first measurement to the UE even if the UE does not need to enter the connected state, which prevents the UE from entering the connected state, saves a process of establishing an RRC connection, reduces delay of the first measurement configuration, saves signaling overhead, and saves power for the UE. If the UE moves under the coverage of a new node, the method supports two modes: UE context redirection and UE context non-redirection, that is, the first measurement configuration information can be successfully transmitted to the UE in both modes, which provides a flexible network implementation method to the operators.

FIG. 6B is a schematic diagram illustrating a fifth example of the radio communication method according to the exemplary embodiment of the present disclosure. Detailed description of steps unrelated to the present disclosure is omitted here. As illustrated in FIG. 6B, the radio communication method includes following steps:

Step 6B01, the content is consistent with that in step 5A01, which will not be repeated here.

Step 6B02, if the selected UE or a specific UE is not under the coverage of the first node, the first node transmits the first paging message to the third node, and the third node may be a base station. The first paging message may be a dedicated paging message (e.g., paging for a specific UE, an RAN paging message) or a group paging message (e.g., paging for multiple UEs). The first paging message includes the first measurement configuration information.

According to one embodiment, if the first paging message is a dedicated paging message, the paging message may include at least one of:
an RRC container, wherein an RRC message, such as an RRC release message may be included in the RRC container, and the RRC release message may include the first measurement configuration information.

According to another embodiment, if the first paging message is a group paging message, the group paging message may include a UE list, the UE list includes IDs and related information of all the paged UEs, and the UE list includes one or more UE paging related information, wherein each UE paging related information includes one of following items:
identification information of the UE, e.g., a UE ID for indicating the paged UE; and
an RRC container, wherein an RRC message, such as an RRC release message, but is not limited thereto, may be included in the RRC container. The RRC message may include the first measurement configuration information.

It should be understood that the above are only examples, and the method of how the first node includes the first measurement configuration information in the first paging message is not limited thereto.

Step 6B03, the third node receives the first paging message from the first node. The third node transmits the paging message to one or more UEs, and the paging message may be a dedicated paging or group paging message.

Step 6B04, in response to the paging message in step 6B03, the UE transmits the third message to the third node, and the third message may be an RRC resume request message or an RRC setup request message, wherein the third message carries an ID and a cause value of the UE (e.g., MT-Access or the indication related to the first measurement).

Step 6B05, the third node knows that the reason why the UE transmits the third message is related to the first measurement according to the ID of the UE and the cause value (e.g., the MT-Access or the indication related to the first measurement) carried in the third message. The third node transmits a fourth message to the UE, where the fourth message is an RRC message in the RRC container obtained in step 6B02, and the RRC message is built by the first node. The RRC message includes the first measurement configuration information.

According to one embodiment, if the UE is in the RRC_INACTIVE state, the forth message is an RRC resume request message or an RRC release message; according to another embodiment, if the UE is in the RRC_IDLE state, the forth message is an RRC setup request message or an RRC release message. It should be understood that the above are only exemplary, and the fourth message is not limited thereto.

Step 6B05, the UE receives the first measurement configuration information, and starts or stops the first measurement according to the first measurement configuration information. If the UE needs to report the first measurement report, the UE transmits the first measurement report to the network according to the information related to the first measurement report.

Through the above radio communication method, it is capable of supporting a network to perform the configuration and reporting of the first measurement (e.g., QoE measurement) for the UE in the inactive state or the idle state and in a moving procedure, and it is also capable of successfully configuring the first measurement and supporting the reporting of the first measurement, so as to facilitate the operators to collect the service (e.g., the broadcast multi-cast service) quality experience situations of the mobile users in the inactive or the idle state, thereby further optimizing and adjusting the network, improving the user service experience, and finally improving user loyalty and increasing operator revenue. The method may also control how the base station selects or decides the UE to perform the first measurement, and flexibly collect the first measurement performed by the UE in different states according to the operator's requirements, so that the operator optimizes the network more purposefully. The method may also maintain the UE in the inactive state or the idle state, and transmit the configuration of the first measurement to the UE even if the UE does not need to enter the connected state, which prevents the UE from entering the connected state, saves a process of establishing an RRC connection, reduces delay of the first measurement configuration, saves signaling overhead, and saves power for the UE. If the UE moves under the coverage of a new node, the method supports that the UE does not need to be relocated to the new node, but the information related to the first measurement can also be transmitted to the UE successfully, and the method does not require interaction between the base stations to perform the UE context retrieve process, so that the signaling overhead between the base stations is saved, and at the same time, the delay of information transmission is reduced.

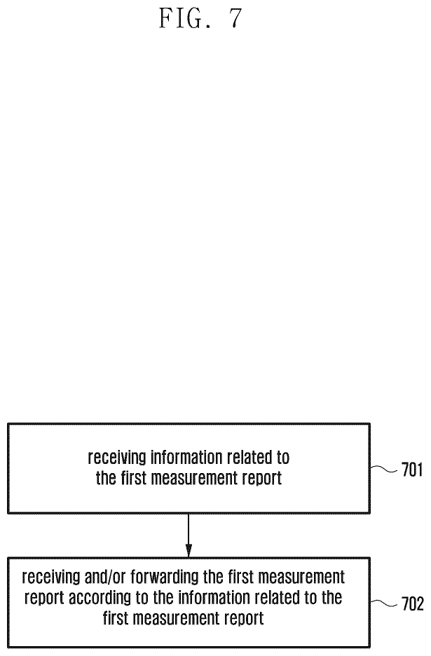

FIG. 7 is a flowchart of a radio communication method executed by a third node according to an exemplary embodiment of the present disclosure.

Detailed description of steps unrelated to the present disclosure is omitted here. As illustrated in FIG. 7, the radio communication method includes the following steps:
Step 701, the third node receives information related to the first measurement report. The third node may be a base station, and the third node is a node currently serving the UE. According to one embodiment, the third node receives the information related to the first measurement report from the UE, the information related to the first measurement report is included in an RRC message, and the RRC message may be an RRC resume request message or an RRC setup request message; according to another embodiment, the third node receives the information related to the first measurement report from a second node, the second node is a base station, the second node has a context of the UE and the third node does not have the context of the UE. It should be understood that the method how the third node receives the information related to the first measurement report is not limited thereto.

The information related to the first measurement report includes at least one of:
an indication for establishing a bearer, for indicating to establish the bearer, wherein the bearer is used for transferring the first measurement, for example, it may be SRB1, SRB2, SRB3 or SRB4, and the indication may be a cause value or in another form;
an indication for transferring the first measurement report, for indicating that a UE needs to transfer the first measurement report;
the first measurement report period information for indicating information of a reporting period of the first measurement report, wherein the reporting period is explicit information of an RRC;
first measurement report segment information for indicating information of segments of the first measurement report, which may be, for example, the number of the segments etc.; and
first measurement collection node information for indicating information of a collection node of the first measurement report, which may be, for example, an MCE ID or a gNB ID, etc.

Step 702, the third node receives and/or forwards the first measurement report according to the information related to the first measurement report.

If the information related to the first measurement report includes the indication for transferring the first measurement report and/or the indication for establishing the bearer, and a bearer X for transferring the first measurement report (e.g., SRB1, SRB2, SRB3, or SRB4, etc.) is not established, the third node establishes a bearer for transferring the first measurement report, and receives the first measurement report from the UE through the established bearer. A process of establishing a bearer is initiated and the bearer is established through the third node, so that the UE may transmit the first measurement report through the established bearer, that is, the third node receives the first measurement report from the UE through the established bearer;
if the information related to the first measurement report includes the first measurement report period information and/or the first measurement report segment information, the third node allocates a corresponding radio resource to the bearer for transferring the first measurement report based on the information, for example, allocates a semi-static scheduling resource according to the report period, so that the signaling for the UE to initiate uplink scheduling is reduced, and resource utilization is improved;
if the information related to the first measurement report includes the first measurement collection node information, the third node forwards the first measurement report to a corresponding collection node according to the first measurement collection node information, after receiving the first measurement report from the UE.

According to the exemplary embodiment, the first measurement report may be obtained by the UE executing the first measurement in the inactive state or the idle state. The first measurement may include a QoE measurement and/or an assistance measurement associated with the QoE measurement, and the first measurement report includes state indication information for indicating the states in which the UE executes the first measurement.

Alternatively, although not shown in FIG. 7, the radio communication method executed by the third node shown in FIG. 7 may further include: receiving the first measurement configuration information from the first node, and transmitting the first measurement configuration information to the UE. For example, the first measurement configuration information may be received from the first node through the retrieve UE context response message or the retrieve UE context reject message, and the received first measurement configuration information is forwarded to the UE (in the example illustrated in FIG. 6A); or, the first measurement configuration information may be received from the first node through the message associated with the UE as the container, and the received first measurement configuration information is forwarded to the UE (in the example illustrated in FIG. 6B), wherein the message associated with the UE includes the first measurement configuration information.

In particular, the receiving of the first measurement configuration information from the first node through the retrieve UE context response message or the retrieve UE context reject message, and the forwarding of the received first measurement configuration information to the UE, include: receiving a first paging message from the first node, wherein the first paging message includes identification information of the UE, or group identification information of a UE group consisting of the at least one UE, or a paging reason; transmitting a retrieve UE context request message to the first node, wherein the UE context request message includes an indication related to the first measurement; receiving a retrieve UE context failure message or a retrieve UE context response message from the first node, wherein the retrieve UE context failure message and the retrieve UE context response message includes the first measurement configuration information; transmitting a second paging message to the UE, and receiving a third message from the UE, wherein the third message includes the indication related to the first measurement; and transmitting an RRC message to the UE, wherein the RRC message includes the first measurement configuration information.

The receiving of the first measurement configuration information from the first node through the message associated with the UE as the container, and the forwarding of the received first measurement configuration information to the UE, may include: receiving the first paging message from the first node, wherein the first paging message includes the container; transmitting the second paging message to the UE; receiving the third message from the UE, wherein the third message includes the indication related to the first measurement; and transmitting the fourth message to the UE, wherein the fourth message is a message associated with the UE. For example, the message associated with the UE includes an RRC message, wherein the RRC message includes an RRC release message or an RRC reject message, or an RRC message includes a Non-Access Stratum (NAS) message, etc. The present disclosure does not limit the types of the RRC messages herein. Through the above radio communication method, it is capable of supporting a network to perform the reporting of the first measurement (e.g., QoE measurement) for the UE in the inactive state or the idle state and in a moving procedure, and it is also capable of supporting the reporting of the first measurement successfully, so as to facilitate the operators to collect the service (e.g., the broadcast multi-cast service) quality experience situations of the mobile users in the inactive or the idle state, thereby further optimizing and adjusting the network, improving the user service experience, and finally improving user loyalty and increasing operator revenue. The radio communication method may also allow the node serving the UE to more reasonably allocate the radio resources to transfer the first measurement report according to the information related to the first measurement report (e.g., the first measurement report period information and/or the first measurement report segment information), that is, unnecessary uplink scheduling request signaling and/or downlink scheduling indication signaling are/is reduced, air interface resources are saved, and consumption of the UE power is reduced.

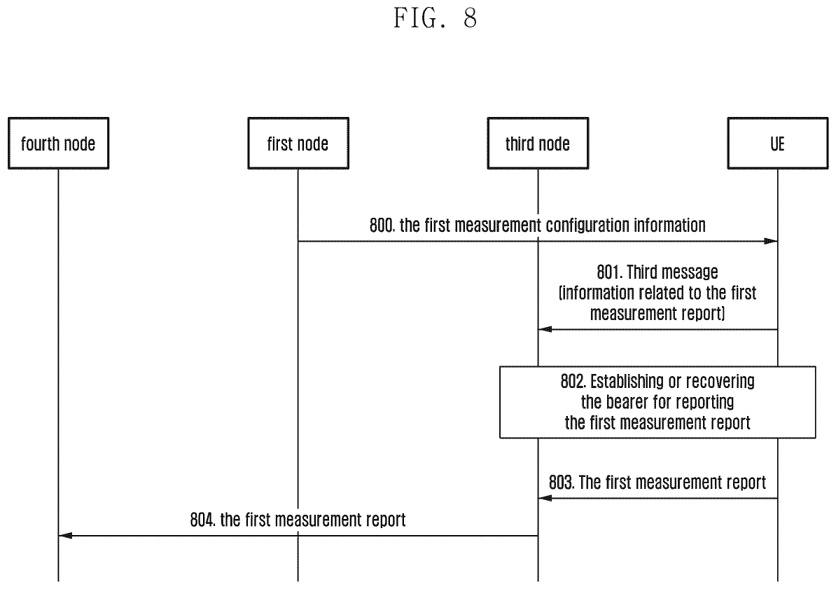

FIG. 8 is a schematic diagram illustrating a sixth example of the radio communication method according to the exemplary embodiment of the present disclosure. Detailed description of steps unrelated to the present disclosure is omitted here. As illustrated in FIG. 8, the method includes following steps:

Step 800, the UE receives the first measurement configuration information from the network (e.g., from the first node), and starts the first measurement. For example, the UE may directly or indirectly receive the first measurement configuration information from the first node. The UE directly receives the first measurement configuration information from the first node if the UE is under coverage of the first node. The UE receives the first measurement configuration information from the first node through the third node if the UE is under coverage of the third node. That is, the third node receives the first measurement configuration information from the first node, and then transmits the first measurement configuration information to the UE. For how the third node receives the first measurement configuration information and transmits the first measurement information to the UE, reference may be made to the relevant descriptions of FIG. 6A and FIG. 6B above. Step 801, if the UE is in the RRC_INACTIVE or RRC_IDLE state and there is the first measurement report to be transmitted, the UE transmits the third message to the third node, the third node may be a base station, and the third node is a node currently serving the UE. According to one embodiment, if the UE is in the RRC_INACTIVE state, the third message is an RRC resume request message; according to another embodiment, if the UE is in the RRC_IDLE state, the third message is an RRC setup request message. It should be understood that the above are only exemplary, and the third message is not limited thereto.

The third message includes the information related to a first measurement report. The information related to the first measurement report includes at least one of:
an indication for establishing a bearer X, for indicating to establish the bearer, wherein the bearer is used for transferring the first measurement, which may be, for example, SRB1, SRB2, SRB3 or SRB4, and the indication may be a cause value or in another form;
an indication for transferring the first measurement report for indicating that a UE needs to transfer the first measurement report;
the first measurement report period information for indicating information of a reporting period of the first measurement report, wherein the reporting period is explicit information of an RRC;
first measurement report segment information for indicating information of segments of the first measurement report, which may be, for example, the number of the segments etc.; and
first measurement collection node information for indicating information of a collection node of the first measurement report, which may be, for example, an MCE ID or a gNB ID, etc.

Step 802, the third node receives the third message, and if the third message includes the indication for establishing the bearer, the third node initiates a process of establishing a bearer.

Step 803, if the bearer is established successfully, the UE transmits the first measurement report to the third node through the bearer, and the first measurement report may be one or more, and may be transmitted once or multiple times.

If the third message includes the first measurement report period information and/or the first measurement report segment information, that is, there are multiple first measurement reports that need to be transmitted multiple times, the third node considers the information, and may allocate the radio resources corresponding to the bearer for transferring the first measurement report to the UE in advance, that is, physical resources used by the semi-static scheduling bearer X are allocated. In this way, it is avoided that the UE transmits a scheduling request to the third node every time it reports, thereby saving scheduling overhead and saving power for the UE.

Step 804, after the third node receives the first measurement report, if the first measurement collection node information is included in the third message, the third node forwards the received first measurement report to the first measurement collection node (such as the fourth node) according to the information. In this way, even if there is no UE context on the third node, it can be ensured that the UE can smoothly transmit the first measurement report to the first measurement collection node through the third node.

Through the above radio communication method, it is capable of supporting a network to perform the reporting of the first measurement (e.g., QoE measurement) for the UE in the inactive state or the idle state and in a moving procedure, and it is also capable of supporting the reporting of the first measurement successfully, so as to facilitate the operators to collect the service (e.g., the broadcast multi-cast services) quality experience situations of the mobile users in the inactive or the idle state, thereby further optimizing and adjusting the network, improving the user service experience, and finally improving user loyalty and increasing operator revenue. The method may also allow the node serving the UE to more reasonably allocate the radio resources to transfer the first measurement report according to the information related to the first measurement report (e.g., the first measurement report period information and/or the first measurement report segment information), that is, unnecessary uplink scheduling request signaling and/or downlink scheduling indication signaling are/is reduced, air interface resources are saved, and consumption of the UE power is reduced.

According to various exemplary embodiments described above, in addition to providing the radio communication method executable by the third node as illustrated in FIG. 7 above, the present disclosure may further provide a radio communication method executed by the first node and a radio communication method executed by the UE.

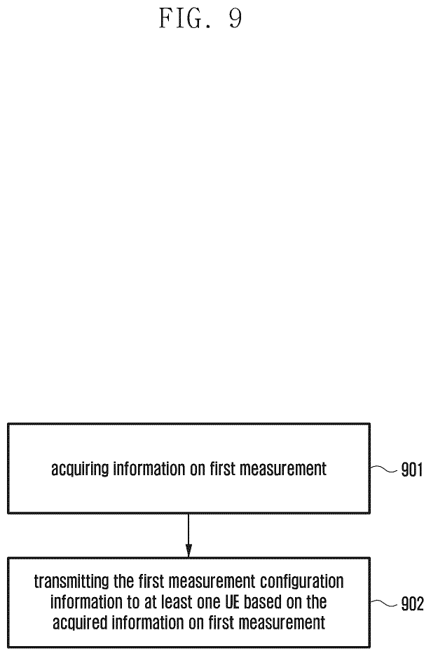

FIG. 9 is a flowchart of a radio communication method executed by a first node according to an exemplary embodiment of the present disclosure.

Referring to FIG. 9, in step 901, information on a first measurement is acquired, for example, the first node receives the information on the first measurement from a second node, or the first node itself generates the information on the first measurement. Here, the first measurement includes QoE measurement and/or assistance measurement associated with the QoE measurement; and/or, the information on the first measurement includes at least one of: information for activating the first measurement, information for deactivating the first measurement, and information for modifying the first measurement.

As an example, the information for activating the first measurement or the information for modifying the first measurement includes at least one of:
contents of the first measurement;
information related to state(s) of the UE to indicate the state(s) in which the UE can execute the first measurement;
condition information of the first measurement, including an area range information, wherein the area range information includes Radio Access Network (RAN) notification area information; and
information related to reporting of a first measurement report, wherein the information related to reporting of the first measurement report includes reporting period information of the first measurement report, and the reporting period information of the first measurement report is explicit.

As an example, in step 901, the information on the first measurement from the second node may be received, and specifically, a first message may be received from a second node, wherein the first message may include the information on the first measurement, wherein a type of the first message is associated with types of the first node and the second node.

In step 902, first measurement configuration information is transmitted to the at least one UE based on the acquired information on the first measurement. The first measurement configuration information is for the UE to execute or stop the first measurement in an inactive state or an idle state. As an example, the transmitting of the first measurement configuration information to the at least one UE based on the acquired information on the first measurement includes: determining the at least one UE to which the information on the first measurement is specific, or selecting or deciding the at least one UE based on the acquired information on the first measurement; and transmitting the first measurement configuration information to the at least one UE if the at least one UE supports the first measurement in the inactive state or the idle state.

In particular, in step 902, if the at least one UE is under the coverage of the first node, the first measurement configuration information is directly transmitted to the at least one UE, and if the at least one UE is under the coverage of the third node, the first measurement configuration information is transmitted to the at least one UE through the third node.

As an example, the directly transmitting of the first measurement configuration information to the at least one UE may include: transmitting a paging message to the at least one UE, receiving a response to the paging message from the at least one UE, and transmitting the first measurement configuration information to the at least one UE through a message associated with UE (as shown in the example in FIG. 5A). The paging message may include a group paging message. A response to the paging message may include a Radio Resource Control (RRC) resume request message or an RRC setup request message. The message associated with the UE may be an RRC message, wherein the RRC message includes an RRC release message or an RRC reject message, or an RRC message including a Non-Access Stratum (NAS) message. In addition, according to the exemplary embodiment, the paging message may include information related to a paging purpose, the information related to the paging purpose may include an indication related to the first measurement, and the RRC resume request message or the RRC setup request message may include a cause value related to the paging purpose.

Alternatively, the directly transmitting of the first measurement configuration information to the at least one UE may include: transmitting the first measurement configuration information to the at least one UE through a message for group notification (as shown in the example in FIG. 5B or FIG. 5C).

According to the exemplary embodiment (such as the example illustrated in FIG. 5B), the transmitting of the first measurement configuration information to the at least one UE through the message for group notification, may include: transmitting a second message to the at least one UE, wherein the second message is a broadcast or multi-cast control message, wherein the broadcast or multi-cast control message includes the first measurement configuration information. In addition, the radio communication method may further include: receiving a third message from a UE for which the first measurement is configured successfully among the at least one UE, wherein the third message includes at least one of identification information of UE and information related to execution of the first measurement.

Alternatively, according to another exemplary embodiment (such as the example illustrated in FIG. 5C), the transmitting of the first measurement configuration information to the at least one UE through the message for group notification, may include: transmitting a second message to the at least one UE, wherein the second message is a broadcast or multi-cast control message, wherein the broadcast or multi-cast control message may include at least one of: an indication related to the first measurement, identification information of the first measurement, and a service corresponding to the first measurement; receiving a third message from a UE which makes a response to the second message among the at least one UE, wherein the third message includes at least one of: the indication related to the first measurement, and the identification information of the first measurement; and transmitting a fourth message to the UE which makes the response to the second message, wherein the fourth message includes the first measurement configuration information.

As stated above, the first measurement configuration information is transmitted to the at least one UE through a third node if the at least one UE is under the coverage of the third node.

For example, the transmitting of the first measurement configuration information to the at least one UE through the third node, may include: transmitting the first measurement configuration information included in a retrieve UE context response message or a retrieve UE context reject message to the third node so as to forward the first measurement configuration information to the at least one UE through the third node (as illustrated in the example illustrated in FIG. 6A). In particular, the transmitting of the first measurement configuration information included in the retrieve UE context response message or the retrieve UE context reject message to the third node, includes: transmitting a first paging message to the third node, wherein the first paging message includes identification information of the at least one UE, or group identification information of a UE group consisting of the at least one UE, or a paging reason; receiving a retrieve UE context request message from the third node, wherein the retrieve UE context request message includes indications related to the first measurement; the first node transmitting a retrieve UE context failure message to the third node if the first node decides not to redirect UE context, wherein the retrieve UE context failure message includes the first measurement configuration information; and the first node transmitting the retrieve UE context response message to the third node if the first node decides to redirect the UE context, wherein the retrieve UE context response message includes the first measurement configuration information.

Alternatively, the transmitting of the first measurement configuration information to the at least one UE through the third node, may include: transmitting a message including the first measurement configuration information and associated with UE as a container to the third node, so as to forward the first measurement configuration information to the at least one UE through the third node (as shown in the example illustrated in FIG. 6B). In particular, for example, the transmitting of the message including the first measurement configuration information and associated with the UE as the container to the third node, may include: transmitting the first paging message to the third node, wherein the first paging message includes the container. As an example, the message associated with the UE may include an RRC message, wherein the RRC message includes an RRC release message or an RRC reject message, or an RRC message including a Non-Access Stratum (NAS) message.

For the details of the communication of the first node with the UE and the third node involved in FIG. 9, reference may be made to the above related descriptions about FIG. 4 to FIG. 8, which will not be repeated here.

According to the above radio communication method, it is capable of supporting a network to perform the first measurement configuration for the UE in the inactive state or the idle state, so as to facilitate the operators to collect the service situations of the users in the inactive or the idle state, thereby further optimizing and adjusting the network, improving the user service experience, and finally improving user loyalty and increasing operator revenue.

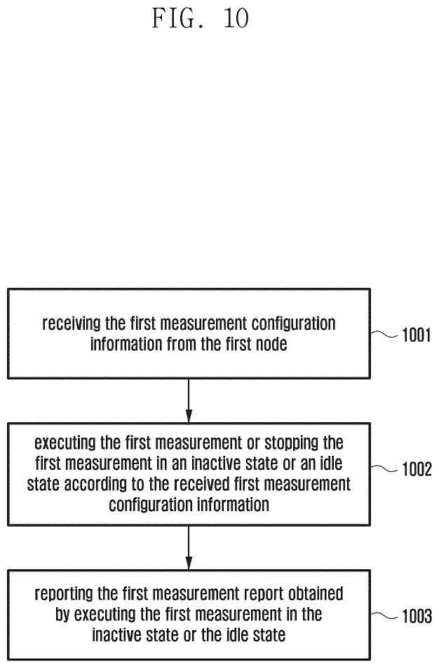

FIG. 10 is a flowchart of a radio communication method executed by UE according to an exemplary embodiment of the present disclosure.

Referring to FIG. 10, in step 1001, first measurement configuration information is received from a first node. The first measurement configuration information may include, for example, at least one of: information for activating the first measurement, information for deactivating the first measurement, and information for modifying the first measurement. The first measurement may include QoE measurement and/or assistance measurement associated with the QoE measurement.

In particular, the UE directly receives the first measurement configuration information from the first node if the UE is under coverage of the first node. The UE receives the first measurement configuration information from the first node through the third node if the UE is under coverage of the third node.

According to the exemplary embodiment (such as the example illustrated in FIG. 5A), the directly receiving of the first measurement configuration information from the first node, includes: receiving a paging message from the first node, transmitting a response to the paging message to the first node, and receiving the first measurement configuration information from the first node through the message associated with the UE. As an example, the paging message may include a group paging message; and/or, the response to the paging message may include a Radio Resource Control (RRC) resume request message or an RRC setup request message; and/or, the message associated with the UE may include an RRC message, wherein the RRC message includes an RRC release message or an RRC reject message, or an RRC message including a Non-Access Stratum (NAS) message. For example, the paging message may include information related to a paging purpose, the information related to the paging purpose may include an indication related to the first measurement, and the RRC resume request message or the RRC setup request message may include a cause value related to the paging purpose.

Alternatively, according to the exemplary embodiment (such as the examples illustrated in FIG. 5B and FIG. 5C), the directly receiving of the first measurement configuration information from the first node, may include: receiving the first measurement configuration information from the first node through a message for group notification.

For example, according to the exemplary embodiment (such as the example illustrated in FIG. 5B), the receiving of the first measurement configuration information from the first node through the message for group notification, may include: receiving a second message from the first node, wherein the second message is a broadcast or multi-cast control message, wherein the broadcast or multi-cast control message includes the first measurement configuration information. Alternatively, the radio communication method further includes: transmitting a third message to the first node if the first measurement of the UE is configured successfully, wherein the third message includes at least one of identification information of the UE and information related to execution of the first measurement.

Alternatively, according to another exemplary embodiment (such as the example illustrated in FIG. 5C), the receiving of the first measurement configuration information from the first node through the message for group notification, may include: receiving a second message from the first node, wherein the second message is a broadcast or multi-cast control message, wherein the broadcast or multi-cast control message includes at least one of: an indication related to the first measurement, identification information of the first measurement, and a service corresponding to the first measurement; transmitting the third message to the first node, wherein the third message includes at least one: the indication related to the first measurement, and the identification information of the first measurement; and receiving a fourth message from the first node, wherein the fourth message includes the first measurement configuration information.

As stated above, the first measurement configuration information is received from the first node through the third node if the UE is under coverage of the third node.

In particular, according to the exemplary embodiment (such as the example illustrated in FIG. 6A), the receiving of the first measurement configuration information from the first node through the third node, may include: receiving the first measurement configuration information received by the third node from the first node through the retrieve UE context response message or the retrieve UE context reject message, from the third node. In particular, for example, the receiving of the first measurement configuration information received by the third node from the first node through the retrieve UE context response message or the retrieve UE context reject message, from the third node, may include: receiving a paging message from the third node; transmitting the third message to the third node in response to the paging message, wherein the third message includes the indication related to the first measurement; and receiving the RRC message from the third node, wherein the RRC message includes the first measurement configuration information received by the third node from the first node through the retrieve UE context response message or the retrieve UE context reject message.

Alternatively, according to another exemplary embodiment (such as the example illustrated in FIG. 6B), the receiving of the first measurement configuration information from the first node through the third node, may include: receiving the first measurement configuration information received by the third node from the first node through the message associated with the UE as the container, from the third node, wherein the message associated with the UE includes the first measurement configuration information. In particular, for example, the receiving of the first measurement configuration information received by the third node from the first node through the message associated with the UE, from the third node, may include: receiving a paging message from the third node; transmitting the third message to the third node in response to the paging message, wherein the third message includes the indication related to the first measurement; and receiving a fourth message from the third node, wherein the fourth message is the message associated with the UE. As an example, the message associated with the UE may include an RRC message, wherein the RRC message includes an RRC release message or an RRC reject message, or an RRC message including a Non-Access Stratum (NAS) message.

Next, in step 1002, according to the received first measurement configuration in- formation, the first measurement is executed or stopped in an inactive state or an idle state. Subsequently, in step 1003, a first measurement report obtained by executing the first measurement in the inactive state or the idle state is reported to a network. For example, the first measurement report may be reported to a node currently serving the UE; or, the first measurement report may be reported to a network entity configured to collect the first measurement report. The node currently serving the UE may be the third node, or may not be the third node, e.g., the first node. In the case where the node currently serving the UE is the third node (e.g., the example illustrated in FIG. 8), the reporting of the first measurement report to the node currently serving the UE may include: transmitting information related to the first measurement report to the third node; and transmitting the first measurement report to the third node so that the third node receives and/or forwards the first measurement report from the UE according to the information related to the first measurement report. As an example, the information related to the first measurement report may include at least one of: an indication for establishing a bearer, wherein the bearer is used to transfer the first measurement report; an indication for transferring the first measurement report; first measurement report period information; first measurement report segment information; and first measurement collection node information.

In addition, the first measurement report may be reported to the network in the connected state, the inactive state or the idle state. As an example, the first measurement report may include state indication information for indicating the states in which the UE executes the first measurement.

For the details of the communication of the UE with the first node and the third node involved in FIG. 10, reference may be made to the above related descriptions about FIG. 4 to FIG. 8, which will not be repeated here.

According to the above radio communication method, it is capable of supporting a network to perform the first measurement and the reporting of the first measurement for the UE in the inactive state or the idle state, so as to facilitate the operators to collect the service situations of the users in the inactive or the idle state, thereby further optimizing and adjusting the network, improving the user service experience, finally improving user loyalty and increasing operator revenue.

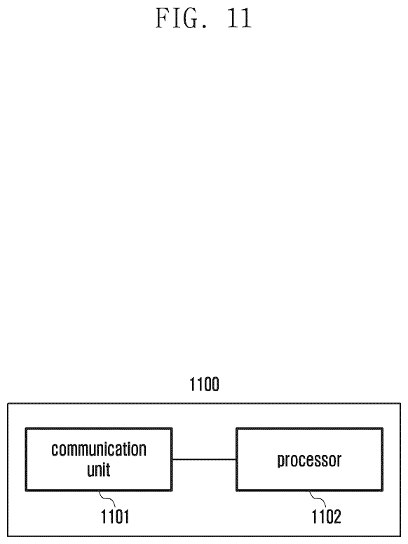

FIG. 11 is a block diagram of a first node according to an exemplary embodiment of the present disclosure.

Referring to FIG. 11, a first node 1100 may include a communication unit 1101 and at least one processor 1102. The at least one processor 1102 may be connected with the communication unit 1101 and configured to: acquire information on a first measurement; control the communication unit 1101 to transmit first measurement configuration information to at least one UE based on the acquired information on the first measurement, wherein the first measurement configuration information is used for executing or stopping the first measurement by UE in an inactive state or an idle state. For details of the above operations, reference may be made to the description of FIG. 9, which will not be repeated here.

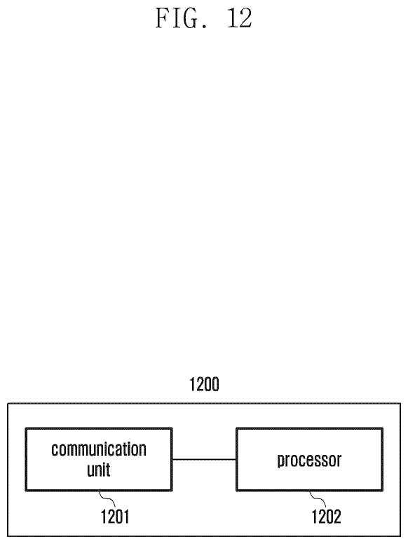

FIG. 12 is a block diagram of an electronic apparatus according to an exemplary embodiment of the present disclosure.

Referring to FIG. 12, a user equipment 1200 may include a communication unit 1201 and at least one processor 1202. The at least one processor 1202 may be connected with the communication unit 1201 and configured to: control the communication unit 1201 to receive first measurement configuration information from a first node; execute or stop the first measurement in an inactive state or an idle state according to the received first measurement configuration information; and control the communication unit 1201 to report a first measurement report obtained by executing the first measurement in the inactive state or the idle state to a network. For details of the above operations, reference may be made to the description of FIG. 10, which will not be repeated here.

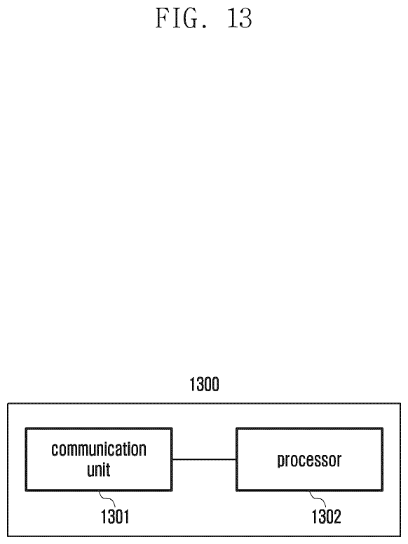

FIG. 13 is a block diagram of a third node according to an exemplary embodiment of the present disclosure.

Referring to FIG. 13, a third node 1300 may include a communication unit 1301 and at least one processor 1302. The at least one processor 1302 may be connected with the communication unit 1301 and configured to: control the communication unit 1301 to receive information related to a first measurement report; and control the communication unit 1301 to receive and/or forward the first measurement report according to the information related to the first measurement report, wherein the first measurement report is obtained by a UE executing the first measurement in an inactive state or an idle state. For details of the above operations, reference may be made to the descriptions of FIG. 7 and FIG. 8, which will not be repeated here.

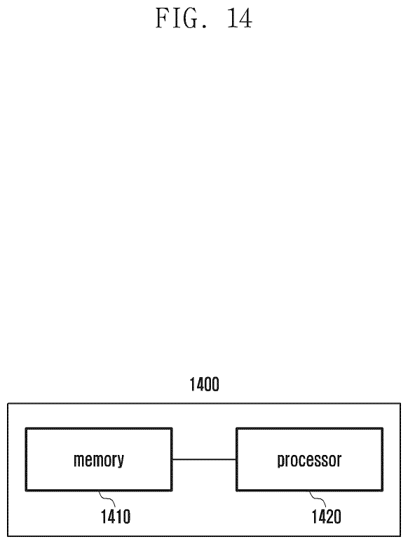

FIG. 14 is a block diagram of an electronic apparatus according to the exemplary embodiment of the present disclosure.

Referring to FIG. 14, an electronic apparatus 1400 may include at least one memory 1410 and at least one processor 1420, the at least one memory stores computer executable instructions, when executed by the at least one processor, causing the at least one processor 1402 to execute the radio communication method according to the exemplary embodiment of the present disclosure.

As an example, the electronic apparatus may be a PC computer, a tablet device, a personal digital assistant, a smart phone, or any other device capable of executing the above indication set. Here, the electronic apparatus does not have to be a single electronic apparatus, and may also be any aggregate of devices or circuits that can execute the above-mentioned indications (or indication sets) individually or jointly. The electronic apparatus may also be a part of an integrated control system or a system manager, or may be a portable electronic device configured to be interconnected with the local or remote (e.g., via wireless transmission) via interfaces.

In the electronic apparatus, the processor may include a central processing unit (CPU), a graphics processing unit (GPU), a programmable logic device, a dedicated processor system, a microcontroller, or a microprocessor. As an example rather than limitation, the processor may also include an analog processor, a digital processor, a microprocessor, a multi-core processor, a processor array, a network processor, and the like.

The processor may run indications or codes stored in the memory, wherein the memory may also store data. Instructions and data may also be transmitted and received over a network via a network interface device, wherein the network interface device may use any known transmission protocol.

The memory may be integrated with the processor, for example, RAM or flash memory is arranged in an integrated circuit microprocessor or the like. In addition, the memory may include a separate device, such as an external disk drive, a storage array, or any other storage device that can be used by a database system. The memory and the processor may be operatively coupled, or may communicate with each other, for example, through an I/O port, a network connection or the like, so that the processor can read files stored in the memory.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

According to the embodiment of the present disclosure, a computer readable storage medium storing instructions may be further provided, wherein the instructions, when executed by at least one processor, cause the at least one processor to execute the radio communication method according to the exemplary embodiment of the present disclosure. Examples of the computer-readable storage medium here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, blu-ray or optical disc storage, hard disk drive (HDD), solid state drive (SSD), card storage (such as, multimedia cards, secure digital (SD) cards or extreme speed digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to the processor or computer so that the processor or computer can execute the computer programs. The instructions or computer programs in the above-mentioned computer-readable storage medium may run in an environment deployed in a computer apparatus such as a client, a host, a proxy device, a server, or the like. In addition, in one example, the computer program and any associated data, data files and data structures are distributed on networked computer systems, so that the computer programs and any associated data, data files and data structures are stored, accessed, and executed in a distributed manner through one or more processors or computers.

Those skilled in the art will easily conceive of other implementation solutions of the present disclosure after considering the description and practicing the invention disclosed herein. The present application is intended to cover any modifications, uses, or adaptive changes of the present disclosure. These modifications, uses, or adaptive changes follow the general principles of the present disclosure and include common knowledge or customary technical means in the technical field that are not disclosed by the present disclosure. The description and the embodiments are only regarded as exemplary, and the true scope and spirit of the present disclosure are defined by the claims.

1. A radio communication method executed by a first node, the method comprising:
acquiring information on a first measurement; and
transmitting first measurement configuration information to at least one UE based on the acquired information on the first measurement,
wherein the first measurement configuration information is used for executing or stopping the first measurement by the UE in an inactive state or an idle state.

2. The radio communication method of claim 1,
wherein the first measurement comprises at least one of a Quality of Experience (QoE) measurement or an assistance measurement associated with the QoE measurement;
wherein the information on the first measurement comprises at least one of: information for activating the first measurement, information for deactivating the first measurement, and information for modifying the first measurement; and
wherein the information for activating the first measurement or the information for modifying the first measurement comprises at least one of: contents of the first measurement; information related to state(s) of the UE to indicate the state(s) in which the UE can execute the first measurement; condition information of the first measurement, the condition information comprising an area range information, wherein the area range information comprises Radio Access Network (RAN) notification area information; and information related to reporting of a first measurement report, wherein the information related to reporting of the first measurement report comprises reporting period information of the first measurement report.

3. The radio communication method of claim 1,
wherein the transmitting of the first measurement configuration information to the at least one UE, comprising: in case that at least one UE is under coverage of the first node, directly transmitting the first measurement configuration information to the at least one UE; and in case that at least one UE is under coverage of the third node,
transmitting the first measurement configuration information to the at least one UE through a third node;
wherein the acquiring of the information on the first measurement comprising: receiving a first message from a second node, wherein the first message comprises the information on the first measurement, wherein a type of the first message is associated with types of the first node and the second node; or generating the information on the first measurement by the first node;
wherein the directly transmitting of the first measurement configuration information to the at least one UE comprising: transmitting a paging message to the at least one UE, receiving a response to the paging message from the at least one UE, and transmitting the first measurement configuration information to the at least one UE through a message associated with UE; or transmitting the first measurement configuration information to the at least one UE through a message for group notification; and
wherein the transmitting of the first measurement configuration information to the at least one UE through the third node, comprising:
transmitting the first measurement configuration information included in a retrieve UE context response message or a retrieve UE context reject message to the third node so as to forward the first measurement configuration information to the at least one UE through the third node;
or transmitting a message including the first measurement configuration information and associated with UE as a container to the third node, so as to forward the first measurement configuration information to the at least one UE through the third node.

4. The radio communication method of claim 3,
wherein the paging message comprises a group paging message, the response to the paging message comprises a Radio Resource Control (RRC) resume request message or an RRC setup request message, and wherein the message associated with UE comprises an RRC message, wherein the RRC message comprises an RRC release message or an RRC reject message, or an RRC message comprising a Non-Access Stratum (NAS) message;
wherein the paging message comprises information related to a paging purpose, the information related to the paging purpose comprises indications related to the first measurement, and the RRC resume request message or the RRC setup request message comprises a cause value related to the paging purpose; wherein the transmitting of the first measurement configuration information to the at least one UE through the message for group notification, comprising: transmitting a second message to the at least one UE, wherein the second message is a broadcast or multi-cast control message, wherein the broadcast or multi-cast control message comprises the first measurement configuration information; or
wherein the transmitting of the first measurement configuration information to the at least one UE through the message for group notification, comprising: transmitting a second message to the at least one UE, wherein the second message is a broadcast or multi-cast control message, wherein the broadcast or multi-cast control message comprises at least one of: an indication related to the first measurement, identification information of the first measurement, and a service corresponding to the first measurement; receiving a third message from a UE which makes a response to the second message among the at least one UE, wherein the third message comprises at least one of: the indication related to the first measurement, and the identification information of the first measurement; and transmitting a fourth message to the UE which makes the response to the second message, wherein the fourth message comprises the first measurement configuration information, and
the radio communication method further comprising: receiving a third message from a UE for which the first measurement is configured successfully among the at least one UE, wherein the third message comprises at least one of identification information of UE and information related to execution of the first measurement

5. The radio communication method of claim 3,
wherein the transmitting of the first measurement configuration information included in the retrieve UE context response message or the retrieve UE context reject message to the third node, comprising:
transmitting a first paging message to the third node, wherein the first paging message comprises identification information of the at least one UE, or group identification information of a UE group consisting of the at least one UE, or a paging reason; receiving a retrieve UE context request message from the third node, wherein the retrieve UE context request message comprises indications related to the first measurement;
in case that the first node does not decide to redirect UE context, the first node transmitting a retrieve UE context failure message to the third node, wherein the retrieve UE context failure message comprises the first measurement configuration information; and in case that the first node decides to redirect the UE context, the first node transmitting a retrieve UE context response message to the third node, wherein the retrieve UE context response message comprises the first measurement configuration information; and
wherein the transmitting of the message including the first measurement configuration information and associated with UE as the container to the third node, comprising: transmitting the first paging message to the third node, wherein the first paging message comprises the container.

6. The radio communication method of claim 1, wherein the transmitting of the first measurement configuration information to the at least one UE based on the acquired information on the first measurement, comprising:
determining the at least one UE to which the information on the first measurement is specific, or selecting the at least one UE based on the acquired information on the first measurement; and
transmitting the first measurement configuration information to the at least one UE if the at least one UE supports the first measurement in the inactive state or the idle state.

7. A radio communication method executed by a user equipment (UE), the method comprising:
receiving first measurement configuration information from a first node;
executing or stopping a first measurement in an inactive state or an idle state according to the received first measurement configuration information; and
reporting a first measurement report obtained by executing the first measurement in the inactive state or the idle state to a network.

8. The radio communication method of claim 7,
wherein the reporting of the first measurement report obtained by executing the first measurement in the inactive state or the idle state to the network, comprising: reporting the first measurement report to a node currently serving UE; or reporting the first measurement report to a network entity configured to collect the first measurement report; and
wherein the node currently serving UE is a third node, and the reporting of the first measurement report to the node currently serving UE comprising: transmitting information related to the first measurement report to the third node; and transmitting the first measurement report to the third node, so that the third node receives and/or forwards the first measurement report from UE according to the information related to the first measurement report.

9. A radio communication method executed by a third node, the method comprising:
receiving information related to a first measurement report; and
receiving and/or forwarding the first measurement report according to the information related to the first measurement report, wherein the first measurement report is obtained by a user equipment (UE) executing the first measurement in an inactive state or an idle state.

10. A first node in a communication system, the first node comprising:
a transceiver capable of transmitting and receiving at least one signal, and
a controller coupled to the transceiver,
wherein the controller is configured to acquire information on a first measurement; and transmit first measurement configuration information to at least one UE based on the acquired information on the first measurement, wherein the first measurement configuration information is used for executing or stopping the first measurement by the UE in an inactive state or an idle state.

11. The first node of claim 10,
wherein the first measurement comprises at least one of a Quality of Experience (QoE) measurement or an assistance measurement associated with the QoE measurement;
wherein the information on the first measurement comprises at least one of: information for activating the first measurement, information for deactivating the first measurement, and information for modifying the first measurement; and
wherein the information for activating the first measurement or the information for modifying the first measurement comprises at least one of: contents of the first measurement; information related to state(s) of the UE to indicate the state(s) in which the UE can execute the first measurement; condition information of the first measurement, the condition information comprising an area range information, wherein the area range information comprises Radio Access Network (RAN) notification area information; and information related to reporting of a first measurement report, wherein the information related to reporting of the first measurement report comprises reporting period information of the first measurement report.

12. The first node of claim 10, wherein the controller is configured to;
in case that at least one UE is under coverage of the first node, directly transmit the first measurement configuration information to the at least one UE; and in case that at least one UE is under coverage of the third node, transmit the first measurement configuration information to the at least one UE through a third node; receive a first message from a second node, wherein the first message comprises the information on the first measurement, wherein a type of the first message is associated with types of the first node and the second node; or generating the information on the first measurement by the first node; transmit a paging message to the at least one UE, receive a response to the paging message from the at least one UE, and transmit the first measurement configuration information to the at least one UE through a message associated with UE; or transmit the first measurement configuration information to the at least one UE through a message for group notification; transmit the first measurement configuration information included in a retrieve UE context response message or a retrieve UE context reject message to the third node so as to forward the first measurement configuration information to the at least one UE through the third node; or transmit a message including the first measurement configuration information and associated with UE as a container to the third node, so as to forward the first measurement configuration information to the at least one UE through the third node; and receive a third message from a UE for which the first measurement is configured successfully among the at least one UE, wherein the third message comprises at least one of identification information of UE and information related to execution of the first measurement;
wherein the paging message comprises a group paging message, the response to the paging message comprises a Radio Resource Control (RRC) resume request message or an RRC setup request message, and wherein the message associated with UE comprises an RRC message, wherein the RRC message comprises an RRC release message or an RRC reject message, or an RRC message comprising a Non-Access Stratum (NAS) message;
wherein the paging message comprises information related to a paging purpose, the information related to the paging purpose comprises indications related to the first measurement, and the RRC resume request message or the RRC setup request message comprises a cause value related to the paging purpose; wherein the transmitting of the first measurement configuration information to the at least one UE through the message for group notification, comprising: transmitting a second message to the at least one UE, wherein the second message is a broadcast or multi-cast control message, wherein the broadcast or multi-cast control message comprises the first measurement configuration information; and
wherein the transmitting of the first measurement configuration information to the at least one UE through the message for group notification, comprising: transmitting a second message to the at least one UE, wherein the second message is a broadcast or multi-cast control message, wherein the broadcast or multi-cast control message comprises at least one of: an indication related to the first measurement, identification information of the first measurement, and a service corresponding to the first measurement; receiving a third message from a UE which makes a response to the second message among the at least one UE, wherein the third message comprises at least one of: the indication related to the first measurement, and the identification information of the first measurement; and transmitting a fourth message to the UE which makes the response to the second message, wherein the fourth message comprises the first measurement configuration information.

13. The first node of claim 10, wherein the controller is configured to;
determine the at least one UE to which the information on the first measurement is specific, or selecting the at least one UE based on the acquired information on the first measurement; and
transmit the first measurement configuration information to the at least one UE if the at least one UE supports the first measurement in the inactive state or the idle state.

14. A User Equipment (UE) in a communication system, the UE comprising:
a transceiver capable of transmitting and receiving at least one signal, and
a controller coupled to the transceiver,
wherein the controller is configured to receive first measurement configuration information from a first node; execute or stop a first measurement in an inactive state or an idle state according to the received first measurement configuration information; and reporting a first measurement report obtained by executing the first measurement in the inactive state or the idle state to a network.

15. A third node in a communication system, the third node comprising:
a transceiver capable of transmitting and receiving at least one signal, and
a controller coupled to the transceiver,
wherein the controller is configured to receive information related to a first measurement report; and receive and/or forwarding the first measurement report according to the information related to the first measurement report, wherein the first measurement report is obtained by a user equipment (UE) executing the first measurement in an inactive state or an idle state.
